(19) United States
(12) Patent Application Publication
(10) Pub. No.: US 2015/0320076 A1
(43) Pub. Date: Nov. 12, 2015

(54) CANDY AND OTHER CARRIERS FORTIFIED WITH TEA POLYPHENOLS or GRAPE SEEDS EXTRACT

(71) Applicant: Wei Xiang, Fontana, CA (US)

(72) Inventor: Wei Xiang, Fontana, CA (US)

(21) Appl. No.: 14/275,407

(22) Filed: May 12, 2014

(51) Int. Cl. A23G 3/48

(52) U.S. Cl. CPC A23G 3/48; A23V 2002/00

(57) ABSTRACT

Candy, jelly, or other confections fortified with tea polyphenols, or grape seeds (skins) extract, serve as antioxidant or weight loss supplements. The combination affords at least four benefits, (1) continuously attracting consumer to ingest more antioxidants to get multiple benefits, (2) conveniently (handily) delivering plenty polyphenols to serve people in need, (3) masking the bitter taste of tea polyphenols, or grape seeds (skins) extract by a flexible formula, (4) improving the oral bioavailability.

### CROSS-REFERENCE TO RELATED APPLICATIONS

This application claims the benefit of provisional patent application No. 61/817,866, and 61/816,785, filed Apr. 30, 2013 and Apr. 28, 2013, the contents of which are herein incorporated by reference.

### SUBSTITUTE SPECIFICATION STATEMENT

This substitute specification includes no new matter.

### SUMMARY OF THE INVENTION

Tea, and grape seed (skins) extract are best source of antioxidants and showed multiple benefits to the health. Candy fortified with TP and GSE afford a perfect solution to settle four questions. The candy pattern may continuously attract consumer to ingest more antioxidants to get multiple benefits. Candy can ingeniously mask bitter taste of TP and GSE by a fine formulation of sweetener and other ingredients. Candy is a very convenient and traditional pattern, and can delivery plenty (sufficient quantity) polyphenols (antioxidants). Candy is best carrier to improve the oral bioavailability.

### DETAILED DESCRIPTION OF THE INVENTION

Tea, and grape seeds (skins) extract are rich in antioxidant polyphenols, such as epigallocatechin gallate and other catechins which have shown multiple bioactivities in medical studies, such as anti-inflammatory, anti atherosclerosis, anti lipid peroxidation, and decreasing the risk of cardiovascular events. Not surprisingly, tea polyphenols, and grape seeds (skins) extract have become widely known products in recent years. Moreover, epidemiological statistics has shown that habitual tea or grape seeds extract consumption can obviously reduce body fat. The deeper studies have revealed that polyphenols, such as epigallocatechin gallate, procyanidins is primary actor in the achievement. The mechanisms can be mainly concluded as followings: (1) Increasing energy expenditure through catechins prolonging the presence of norepinephrine. (2) Increasing fat mobilization and oxidation. (3) Suppressing appetite. (4) Regulating the absorption of nutrients, such as reducing carbohydrate absorption 25-50%.

Both of tea polyphenols (TP) and grape seeds (skins) extract (GSE) are an safe and effective nutritional supplement to reduce body fat, extinguish free radicals and to prevent several chronic degenerative diseases. Tea polyphenols are extracted from tea, and consist in a mixture of polyphenols. The mixture is better than purified phenolic compounds, because the composited polyphenols have synergistic effect, which resulting in an overall effect is greater than the sum of individual effects of polyphenols. Tea is most popular beverage in Asian countries, such as China, Japan, but Americans have never showed great interest to the eastern drink. Grape seeds (skins) extract is a new inventive antioxidant, the taste even is worse than tea's. How to let Americans ingesting more TP and GSE to get the multiple benefits, and how to explore new delivery method to improve consumption of TP and GSE in USA is always concerned by the industries and health organizations. Other questions to these antioxidants are how to conveniently take them in a very long term, and how to attract consumer enjoying them and never forget taking them on time. This invention, candy fortified with TP and GSE afford a perfect solution to settle above two questions. The candy form achieves to attract consumers and let them never forget the antioxidants. Candy also can ingeniously mask bitter taste of TP and GSE by a fine combination of sweetener, acid and flavoring. Moreover, candy is a very convenient and traditional pattern, and can delivery plenty (sufficient quantity) polyphenols to those consumers who are really in need of these polyphenols. Candy also is best carrier to improve the oral bioavailability.

Tea is most widely consumed beverage in the world, with annual production of 4.5 million metric tons. Among common food and beverage products, tea has one of the highest contents of polyphenols, about 20-35% of the total dry weight of tea leaves. The marketed tea polyphenols also called “tea extract” consist of 30%-100% polyphenols. The largest type of polyphenols in tea leaves is catechins, which include epigallocatechin-3-gallate (EGCG), epicatechin (EC), epicatechin-3-gallate, epigallocatechin, catechin, and gallocatechin. Some studies showed that the antioxidant power of EGCG is 10 times greater than vitamin C.

The manufactural method of TP is using water, carbon dioxide or alcohols to extract ground tea leaves, then, condensing extracting solution and drying it to yield final products. Sometimes, multiple drying, grind, and purification procedures may be adopted in the manufacture. The alcohol extracting solvents can be methanol, ethyl alcohol, isopropanol, acetone or acetic ester diluted or not with water.

Grape seeds extract is from the seed (and skins) of grapes, which are formed as a by-product of wine making. It also has a great concentration of polyphenols. The GSE consist of 30%-100% polyphenols. The manufactual method is same as TP's

The candy of the present invention is orally administered, and which comprise a serving size of polyphenols about 20 to 900 mg per day. The candy optionally comprises sugar, corn syrup, organic acid, flavoring, and coloring. The candy comprising sugar and corn syrup may be optionally replaced by noncaloric sweetener to create a sugar-free substitute. The sugar also can optionally replaced by low carbohydrate sweetener to create a low carbohydrate substitute.

For example, a very simple and tasteful low carbohydrate candy (per 100 pieces) is made by following ingredients: 10 g TP or GSE extract (90% polyphenols), 5 g Vitamin C, 70 g citric acid, 0.1 g flavoring, 0.1 g coloring, 20 g pectin, 7 g aspartame, and 500 g erythritol. The serving size is approximately 2 to 5 pieces per day, wherein the active ingredients included will be 180 to 450 mg polyphenols.

NOTE: TP=Tea Polyphenols; GSE=Grape Seeds (Skins) Extract

1. One serving size (or per piece) of a candy or other carrier contains 10-800 mg tea polyphenols, or grape seeds (skins) extract (purity may be less than 100%). The polyphenols should be less than 60% weight of finished product to keep it does not taste bitter.

2. The carrier (sugary, sugar free, or low carbohydrate) is a confection, such as jelly, pudding, hard candy, soft candy, gummi candy, taffy, caramel candy, fudge, chewing gum, or chocolate.

3. The composition consists of tea polyphenols, or grape seeds (skins) extract (including partially or fully purified ingredients from tea and grape), and may blend with other ingredients, such as juice, vitamins, or herbal extract.
